(19) United States
(12) Patent Application Publication
(10) Pub. No.: US 2018/0167394 A1
(43) Pub. Date: Jun. 14, 2018

(54) CONTROLLING ACCESS TO A LOCKED SPACE USING CRYPTOGRAPHIC KEYS STORED ON A BLOCKCHAIN

(71) Applicant: Wal-Mart Stores, Inc., Bentonville, AR (US)

(72) Inventors: Donald R. High, Noel, MO (US); Bruce Walter Wilkinson, Rogers, AR (US); Todd Mattingly, Bentonville, AR (US); John J. O'Brien, V, Farmington, AR (US); Robert Cantrell, Herndon, VA (US); Brian Gerard McHale, Oldham (GB); Joseph Jurich, Jr., Molino, FL (US)

(21) Appl. No.: 15/840,663

(22) Filed: Dec. 13, 2017

Related U.S. Application Data
(60) Provisional application No. 62/433,962, filed on Dec. 14, 2016.

(51) Int. Cl. H04L 29/06; H04L 9/32; H04L 9/08

(52) U.S. Cl. CPC H04L 63/10; H04L 9/0825; H04L 63/108; H04L 9/3247

(57) ABSTRACT

A method for controlling access to a locked space, including generating an access code and a private key associated with the access code, hashing the access code to obtain a hashed access code, encrypting the hashed access code with a public key to create a digital signature, wherein the hashed access code and the digital signature are stored on the blockchain, authenticating a receiving device in response to a request from the receiving device to gain access to the locked space, transmitting the private key and the digital signature to an authenticated receiving device, instructing the authenticated receiving device to decrypt the digital signature using the private key to obtain the hashed access code, and transmit the hashed access code to the computing system, and unlocking the locked space in response to receiving the hashed access code from the receiving device.

### RELATED APPLICATIONS

This application claims the benefit of U.S. Provisional Patent No. 62/433,962 filed Dec. 14, 2016, entitled “Controlling Access to a Locked Space Using Cryptographic Keys Stored on a Blockchain,” the contents of which are incorporated by reference herein in their entirety.

### FIELD OF TECHNOLOGY

The following relates to controlling access to a locked space, and more specifically to a method and system for controlling access to a locked space using the blockchain.

### BACKGROUND

Permission to access to a real or virtual space can be granted by a user, but securely controlling or limiting the access is much more difficult. Distributing physical keys that can be used to access a space is risky because physical keys are susceptible to being lost, stolen, or copied. Providing a passcode to another person that electronically locks/unlocks a door is also risky, and requires the user to change the passcode each time the passcode is provided to keep up with security. Further, passcode devices can be unlawfully hacked or overridden by various electronic devices.

Thus, there is a need for a method and system for controlling access to a locked space using cryptographic keys stored on the blockchain.

### SUMMARY

A first aspect relates to a method for controlling access to a locked space, comprising: generating, by a processor of a computing system, an access code and a private key associated with the access code, the access code being used to gain access to the locked space, hashing, by the processor, the access code to obtain a hashed access code, encrypting, by the processor, the hashed access code with a public key to create a digital signature, wherein the hashed access code and the digital signature are stored on a block of a blockchain, authenticating, by the processor, a receiving device in response to a request from the receiving device to gain access to the locked space, transmitting, by the processor, the private key and the digital signature to an authenticated receiving device, instructing, by the processor, the authenticated receiving device to decrypt the digital signature using the private key to obtain the hashed access code, and transmit the hashed access code to the computing system, and unlocking, by the processor, the locked space in response to receiving the hashed access code from the receiving device

A second aspect relates to a computer system, comprising: a processor, at least one input mechanism coupled to the processor, a memory device coupled to the processor, and a computer readable storage device coupled to the processor, wherein the storage device contains program code executable by the processor via the memory device to implement a method for controlling access to a locked space, the method comprising: generating, by a processor of a computing system, an access code and a private key associated with the access code, the access code being used to gain access to the locked space, hashing, by the processor, the access code to obtain a hashed access code, encrypting, by the processor, the hashed access code with a public key to create a digital signature, wherein the hashed access code and the digital signature are stored on a block of a blockchain, authenticating, by the processor, a receiving device in response to a request from the receiving device to gain access to the locked space, transmitting, by the processor, the private key and the digital signature to an authenticated receiving device, instructing, by the processor, the receiving device to decrypt the digital signature using the private key to obtain the hashed access code, and transmit the hashed access code to the computing system, and unlocking, by the processor, the locked space in response to receiving the hashed access code from the receiving device.

A third aspect relates to a computer program product, comprising a computer readable hardware storage device storing a computer readable program code, the computer readable program code comprising an algorithm that when executed by a computer processor of a computing system implements a method for controlling access to a locked space, comprising: generating, by a processor of a computing system, an access code and a private key associated with the access code, the access code being used to gain access to the locked space, hashing, by the processor, the access code to obtain a hashed access code, encrypting, by the processor, the hashed access code with a public key to create a digital signature, wherein the hashed access code and the digital signature are stored on a block of a blockchain, authenticating, by the processor, a receiving device in response to a request from the receiving device to gain access to the locked space, transmitting, by the processor, the private key and the digital signature to an authenticated receiving device, instructing, by the processor, the receiving device to decrypt the digital signature using the private key to obtain the hashed access code, and transmit the hashed access code to the computing system, and unlocking, by the processor, the locked space in response to receiving the hashed access code from the receiving device.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a block diagram of an access control system, in accordance with embodiments of the present invention;

FIG. 2 depicts a block diagram of a receiving device, in accordance with embodiments of the present invention

FIG. 3 depicts an embodiment of a publicly distributable transactions ledger, in accordance with embodiments of the present invention;

FIG. 4 depicts a blockchain and two exemplary blocks of the blockchain, in accordance with embodiments of the present invention.

FIG. 5 depicts a flow chart of a method for controlling access to a locked space, in accordance with embodiments of the present invention;

FIG. 6 depicts a flow chart of a step of the method for controlling access to a locked space of FIG. 5, in accordance with embodiments of the present invention; and

FIG. 7 illustrates a block diagram of a computer system for the access control system of FIG. 1, capable of implementing methods for controlling access to a locked space, in accordance with embodiments of the present invention.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

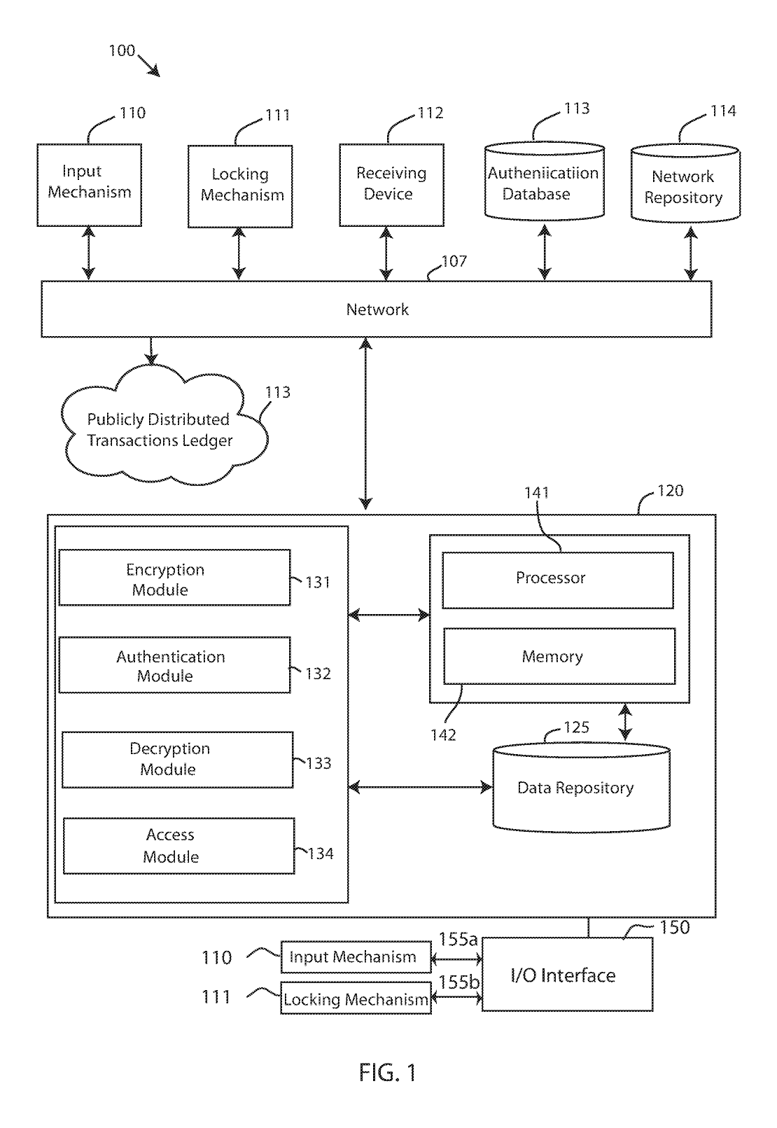

Referring to the drawings, FIG. 1 depicts a block diagram of an access control system 100, in accordance with embodiments of the present invention. Embodiments of an access control system 100 may be described as a system for controlling, providing, monitoring, regulating, etc. an access or entry to a locked or otherwise inaccessible real or virtual space, wherein the access code that provide access is cryptographically stored on the blockchain. Embodiments of the access control system 100 may comprise an input mechanism 110 and a locking mechanism 111 communicatively coupled to the computing system 120 over via an I/O interface 150 and/or over a network 107. For instance, the input mechanism 110 and the locking mechanism 111 may be connected via an I/O interface 150 to computer system 120 via data bus lines 155a, 155b (referred to collectively as “data bus lines 155) and/or over network 107. As shown in FIG. 1, the input mechanism 110 and locking mechanism 111 may transmit information/data to the computing system 120. For example, one or more input mechanisms 110 coupled to the computing system may detect a presence of a receiving device 112, within a predefined proximity of a locked space, and notify the computing system 120 via the data bus lines 155 to an I/O interface 150 of the presence of the receiving device 112. Embodiments of the locking mechanism 111 may receive a signal from the computing device 120 to lock or unlock the locked space, such as unlocking a physical lock on a tangible device enclosing or otherwise preventing access to the locked space, via the data bus lines 155 to the I/O interface 150. An I/O interface 150 may refer to any communication process performed between the computer system 120 and the environment outside of the computer system 120, for example, the input mechanism 110 and the locking mechanism 111. Input to the computing system 120 may refer to the signals or instructions sent to the computing system 120, for example the data collected, detected, captured, etc. by the input mechanism 110, while output may refer to the signals sent out from the computer system 120, such as a command to the locking mechanism 111 to actuate a locking device.

Alternatively, the input mechanism 110 may detect a presence of a receiving device potentially worn by a person approaching the locked space, and transmit the collected data or otherwise notify the computing system 120 over network 107. Embodiments of the locking mechanism 111 may control or actuate one or more locking devices associated with a locked space, and may send and receive information and/or commands from the computing system 120 over network 107. A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the network 107 may be a peer-to-peer network in some embodiments, wherein in other embodiments, the network 107 may be organized as a client/server architecture.

In some embodiments, the network 107 may further comprise, in addition to the computing system 120, input mechanism 110, locking mechanism 111, and receiving device 112, a connection to one or more network accessible knowledge bases containing information of one or more users, network repositories 114 or other systems connected to the network 107 that may be considered nodes of the network 107. In some embodiments, where the network repositories 114 allocate resources to be used by the other nodes of the network 107, the computing system 120 and network repository 114 may be referred to as servers.

The network repository 114 may be a data collection area on the network 107 which may back up and save all the data transmitted back and forth between the nodes of the network 107. For example, the network repository 114 may be a data center saving and cataloging data regarding instances of the locked space being accessed to generate both historical and predictive reports regarding a particular user or locked space; additionally, changes in the blockchain may also be saved and catalogued. In some embodiments, a data collection center housing the network repository 114 may include an analytic module capable of analyzing each piece of data being stored by the network repository 114. Further, the computing system 120 may be integrated with or as a part of the data collection center housing the network repository 114. In some alternative embodiments, the network repository 114 may be a local repository (not shown) that is connected to the computing system 120.

Referring still to FIG. 1, embodiments of the computing system 120 may receive data and other information from the input mechanism 110 and the locking mechanism 111 which may be present internal or external to an environment of a locked space. Embodiments of the locked space may be real or virtual space, and may include a space, opening, room, area, place, hole, chamber, cavity, nook, hollow, compartment, slot, enclosure, section, container, chest, packet, carton, strongbox, and the like. Further, embodiments of the locked space may be an interior or space located within or associated with a house, a box, a delivery receptacle (e.g. a smart box for receiving delivered parcel or packages), an office, a room, a chat room, a computer, a smartphone, a laptop, a tablet, a cloud application, a cloud server, a cloud storage, a physical storage unit, an apartment, a hall, a vehicle, a transportation device, a safe, and the like Moreover, embodiments of the input mechanism 110 may be a sensor, an input, an input device, or any device that can detect a presence of a receiving device 112. For instance, embodiments of the input mechanism 111 may be a camera, a scanner, a RFID scanner, an optical sensor, and the like, that may detect a presence of, or communicate with, a chip, a RFID tag, a processor, or a physical presence of a receiving device 112. The input mechanism 110 may detect the receiving device 112 when the receiving device 112 is within a predefined proximity to the locked space. Embodiments of the input mechanism 110 may scan, read, analyze, or otherwise retrieve information from the receiving device 112. The input mechanism 110 may have a transmitter for transmitting scanned or captured information to the computing system 120. Embodiments of the input mechanism 110 may be placed around or otherwise near the locked space (e.g. camera near front door of a house), may be physically attached to the locked space (e.g. scanner attached to a delivery receptacle for packages), or may be a built-in hardware component of a device containing the locked space (e.g. camera of a smartphone).

Furthermore, embodiments of the locking mechanism 111 may be an electronic actuator for actuating or otherwise controlling a locking device or locking command of a locked space or locked device. The locking mechanism 111 may have a controller or processor that sends a command to move a locking device, such as a lock or lever, in one or directions to move from a locked position to an unlocked position. Embodiments of the locking mechanism 111 may have a transmitter/receiver for transmitting and sending commands, information, data, etc. to the computing system 120. Embodiments of the locking mechanism 111 may be placed around or otherwise near the locked space (e.g. remote controller to control electronic lock of the front door of a house), may be physically attached to the locked space (e.g. electronic lock attached to delivery receptacle), or may be a built-in hardware component of a device containing the locked space (e.g. thumbprint sensor of a smartphone that acts a “home button”) The biometric scanner may have a transmitter for transmitting scanned biometric information to the computing system 120.

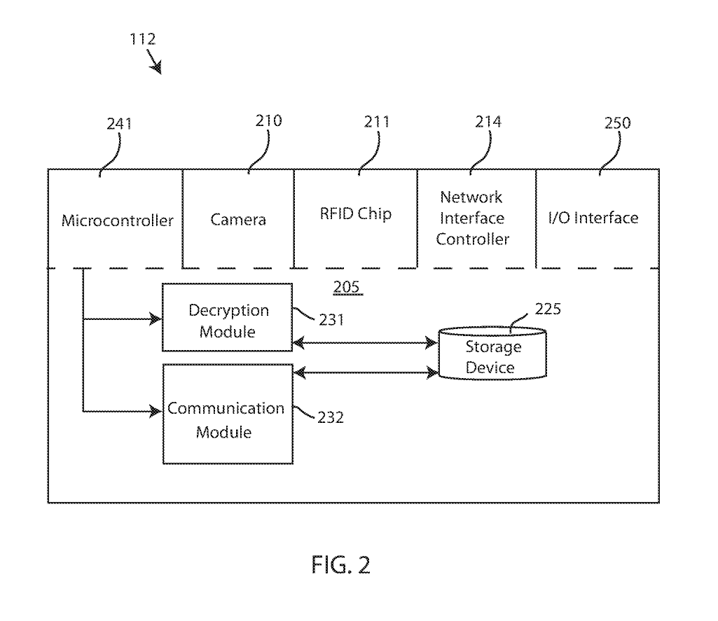

FIG. 2 depicts a block diagram of a receiving device 112, in accordance with embodiments of the present invention. Embodiments of the receiving device 112 may be configured to be worn or otherwise possessed by a person. Embodiments of the receiving device 112 may be a bracelet, a wearable computing device, a ring, an accessory, a necklace, a badge, and the like. The receiving device 112 may be a computing device, a wearable device, a communication device, an access device, or any device that can cooperate and/or communicate with the computing system 120 to facilitate access to a locked space or locked device. Furthermore, embodiments of the receiving device 112 may include a housing or enclosure that may house, protect, or otherwise comprise one or hardware components such as a processor or microcontroller 241, camera 210, RFID chip 211, network interface controller 214, and I/O interface 250. Software components of the receiving device 112 may be located in a memory system 205 of the receiving device 112. Embodiments of the receiving device 112 may include a microcontroller 241 for implementing the tasks associated with the receiving device 112. The RFID chip 211 (or specialized chip) may include various information that may be communicated to the input mechanism 110 and/or to the computing system 120, such as identifying information of the device and/or user associated with the chip 211. Further, embodiments of the receiving device 112 may include a camera 210 verify a locked space. For example, the receiving device 112 may be required to scan a unique identifier of the locked space or locked device before requesting access.

Embodiments of the network interface controller 214 may be a hardware component of the receiving device 112 that may connect the receiving device 112 to network 107. The network interface controller may transmit and receive data, including the transmission of commands and of data stored on the receiving device 112. In some embodiments, the data, such as a private key, may be stored in storage device 225 of memory system 205 of the receiving device 112, when received from the computing system 120. The network interface controller 214 may access the storage device 225, and transmit data over the network 107 to the computing system 120. Additionally, embodiments of receiving device 112 may include an I/O interface 250. An I/O interface 250 may refer to any communication process performed between the receiving device 112 and the environment outside of the receiving device 112.

Furthermore, embodiments of the memory system 205 of the receiving device 112 may include a decryption module 231 and a communication module 232. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory system 205 of the receiving device 112. A module (whether hardware, software, or a combination thereof) may be designed to implement or execute one or more particular functions or routines.

Embodiments of decryption module 231 may include one or more components of hardware and/or software program code for decrypting a digital signature using a private key transmitted by the computing system 120 to obtain a hashed access code to the locked space or locked device. As will be described in greater detail infra, embodiments of the decryption module 232 may apply a decryption using a cryptographic key to obtain a hashed access code for the locked space, which is stored on a block of the blockchain. Moreover, embodiments of the receiving device 112 may include a communication module 232. Embodiments of the communication module 232 may include one or more components of hardware and/or software program code for transmitting the hashed access code to the computing system, so that the computing system 120 sends a signal to the locking mechanism 111 to actuate a locking device to provide access to the locked space.

Referring back to FIG. 1, embodiments of the computing system 120 may include an encryption module 131, an authentication module 132, a decryption module 133, and an access module 134. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computing system 120. A module (whether hardware, software, or a combination thereof) may be designed to implement or execute one or more particular functions or routines.

Embodiments of the encryption module 131 may include one or more components of hardware and/or software program code for generating an access code and a private key, hashing the access code, and encrypting the hashed access code using a public key. For instance, embodiments of the encryption module 131 may generate, create, establish, spawn, or otherwise provide an access code that is associated with locking and unlocking a particular locked space. Embodiments of the access code may be a code or password that is required to actuate a locking mechanism 111 to provide access to a locked space. The access code may be valid forever or may be valid for a limited time, and may be regenerated after each time the space is accessed. Embodiments of the access code may be text, a song or clip thereof, a book or excerpt thereof, a movie clip, digits, bytes, binary digits, bits, characters, an image, a noise, a biological signature (e.g. biometric of owner of the locked space), DNA sequence, a famous quote, a unique identifier, or any indicia or password or code that is computer readable. The access code may be generated based on an algorithm for outputting random combinations of characters, digits, symbols, etc., or may be generated based on user defined parameters, such as favorite movies, songs, etc., wherein the computing system 120 uses the whole or as portion of a digital file. The user defined parameters may be retrieved from a server services an application running on the user's smartphone, as an example. Embodiments of the access code may be data of arbitrary size, both large and small. In response to a generation of the access code, the encryption module 131 may hash the access code using a hashing function to map the data of arbitrary size to a fixed size. For instance, the encryption module 131 may hash the access code using a cryptographic hashing function.

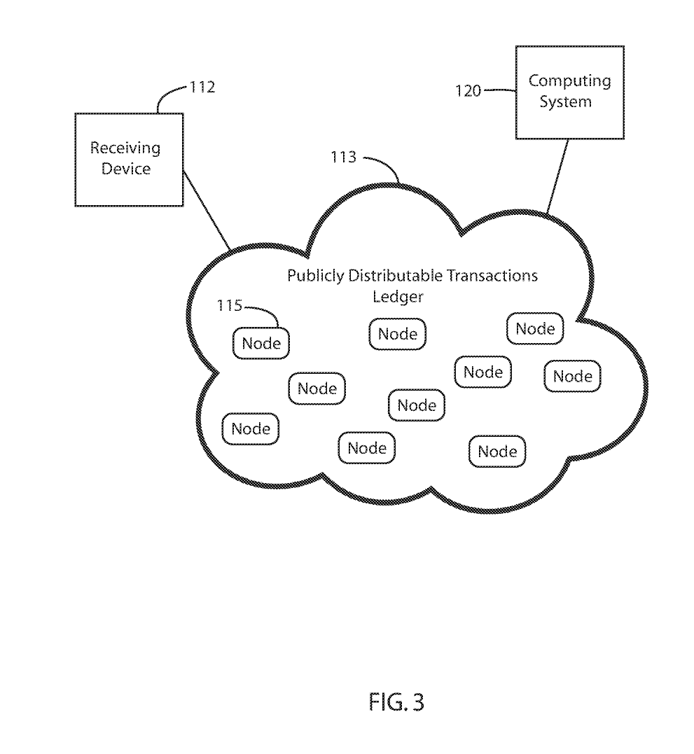

Moreover, embodiments of the encryption module 131 may encrypt the hashed access code (or encrypt the access code without performing a hashing function). The access code or the hashed access code may be encrypted with a public key (or private key in some embodiments) to create a digital signature. The private key and the public key may be generated by the encryption module 131 at the same time. The public key and the private key may be generated along with a generation of the access code, or in response to the generation of the access code. Embodiments of the private key and the public key may be cryptographic keys. The private key may be unique to one device, person, account, etc. In one embodiment, the access code or hashed access code may be encrypted with the public key to create a digital signature. In other embodiments, the access code or hashed access code may be encrypted with the private key to create a digital signature. Embodiments of the digital signature may then be stored on a block of a blockchain, such as publicly distributed transaction ledger 113. Embodiments of the computing system 120 may further include a blockchain module(s) that include one or more components of hardware and/or software program code for accessing and/or utilizing the publicly distributed transactions ledger 113 (i.e. blockchain) to store and/or view transaction information, such as the hashed access code and the digital signature, details regarding who is requesting access, who is providing access, time details, the space, and, the like, using the public key and/or the private key generated by the computing system 120. Transaction information may be recorded on the publicly distributable transactions ledger 113. The recordation of the access-related transactions is immutable and almost impossible to fraudulently change the details of the transactions stored on the ledger 113 due to the nature of the decentralized ledger, otherwise referred to as the blockchain. FIG. 3 depicts an embodiment of a publicly distributable transactions ledger 113, in accordance with embodiments of the present invention. Embodiments of ledger 113 may be a distributed peer-to-peer network, including a plurality of nodes 115. The ledger 113 may represent a computing environment for operating a decentralized framework that can maintain a distributed data structure. In other words, ledger 113 may be a secure distributed transaction ledger or a blockchain that may support document management. Each node 115 may maintain an individual public ledger (i.e. maintained publicly) according to set procedures that employ cryptographic methods and a proof-of-work concept. In view of the public nature of the ledger and the proof-of-work concept, the nodes 115 collectively create a decentralized, trusted network. Further, embodiments of the publicly decentralized trusted ledger 113 may be accessible by the computing system 120 and the receiving device 112 for verifying a transaction, completing a transaction, or viewing transactions details.

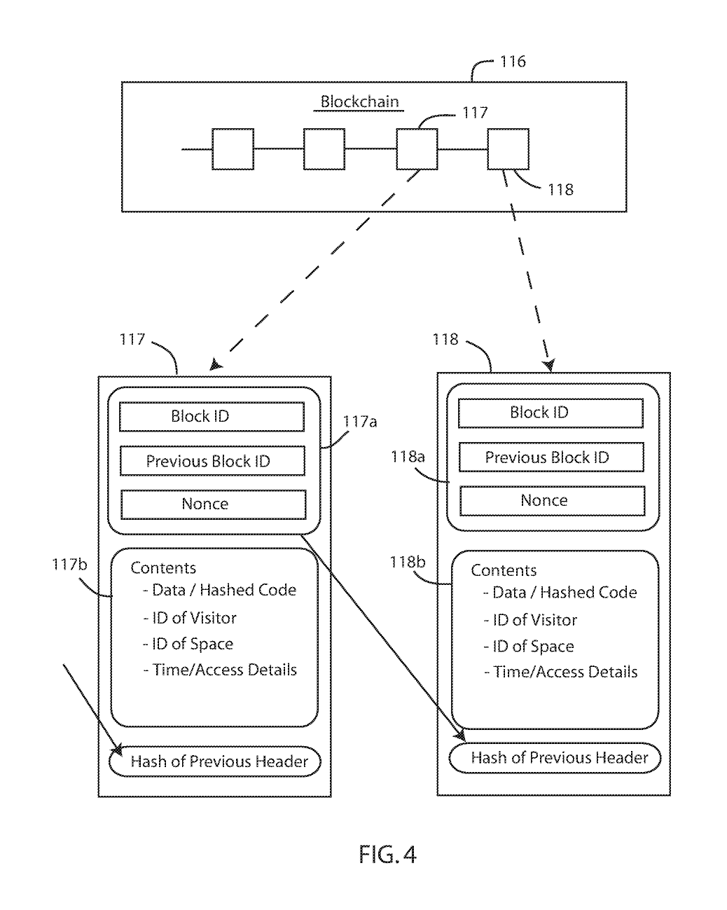

FIG. 4 depicts a blockchain 116 and two exemplary blocks 117, 118 of the blockchain 116, in accordance with embodiments of the present invention. Embodiments of the blockchain 116 may represent the publicly distributable transactions ledger 113, and may include a plurality of blocks. Each block, such as block 117 and block 118 may include data regarding recent transactions and/or contents relating to access of a particular space, linking data that links one block 118 to a previous block 117 in the blockchain, proof-of-work data that ensures that the state of the blockchain 116 is valid, and is endorsed/verified by a majority of the record keeping system. The confirmed transactions of the blockchain are done using cryptography to ensure that the integrity and the chronological order of the blockchain are enforced and can be independently verified by each node 115 of the blockchain 116. New transactions may be added to the blockchain 116 using a distributed consensus system that confirms pending transactions using a mining process, which means that each transaction can easily be verified for accuracy, but very difficult or impossible to modify. Moreover, embodiments of a block 117 of the blockchain 116 may include a header 117a and a content 117b. Embodiments of the header 117a may include a block ID, a previous block ID, and a nonce. The nonce may represent a proof-of-work. The header 117a may be used to link block 117 to other blocks of the blockchain. Embodiments of the block contents 117b may include transaction information relating to a hashed access code or a digital signature. Likewise, block 118 may include a header 118a and contents 118b. Block 118 includes a hash of the previous block's header (i.e. 117a), thereby linking the blocks 117, 118 to the blockchain.

The transaction information cannot be modified without at least one of the nodes 115 noticing; thus, the blockchain 116 can be trusted to verify transactions occurring on the blockchain 116. Further, the computing system 120 may access the blocks of a blockchain 116 that include access-related records using the cryptographic keys. Accordingly, embodiments of the computing system may use the public key and the private key generated by the computing system 120 to gain access to blockchain 116. Furthermore, a new transaction may be generated on the blockchain that the receiving device gained access to the locked space on the blockchain using the private key. This may prevent the receiving device 112 from using the same hashed code than once in situations where access may be granted for a single time only. The computing system 120 can treat the hashed access code as one cryptocurrency unit, and when the hashed access code is sent to the computing system 120, the lone cryptocurrency unit is spent. Any attempt to resend the hashed access code will not be successful in gaining access because the computing system 120 will access the blockchain, which by virtue of the distributed ledger, will not issue a consensus that the receiving device 112 has a remaining cryptocurrency to spend on gaining access to a particular locked space.

Referring back to FIG. 1, embodiments of the computing system 120 may include an authentication module 132. Embodiments of the authentication module 131 may include one or more components of hardware and/or software program code for authenticating a receiving device 112 requesting access to a locked space. A receiving device 112, which may be a mobile computing device or smartphone of a user, may transmit a request to computing system 120 to access to a locked space at a particular time. The requested access time may be intended for an instant access to the locked space, or may be scheduled for a time in the future. The request may be transmitted by the receiving device 112 over network 107, and may be received by the authentication module 132, for processing the request. The request from the receiving device 112 may be seeking access based on an agreement to access the locked space, an offer to access the locked space, permission received to access the locked space, scheduled delivery to the locked space, and the like, the transaction and/or details of which may be stored on an authentication database 113. Embodiments of the authentication database 113 may be one or more databases, servers, storage devices, nodes, etc. that store transactions relating to accessing a locked space. For example, the authentication database 113 may include data and/or information on a parcel being shipped to a locked delivery receptacle at a particular location. The delivery person charged with delivering the parcel may carry a handheld device (e.g. a receiving device 112), and may approach the locked delivery box to deliver the parcel. The device 112 may send a request to the computing system 120 as part of an authenticating step of providing access to the locked space. In response to receiving the request, the authentication module 132 of the computing system 120 may access authentication database 113 to verify that indeed the delivery receptacle is expecting a parcel delivery on that particular day. As part of the request, the receiving device 112 may also transmit unique identifying information of the parcel to the computing system 120, which may also be stored on the authentication database 113. Thus, the authentication module 132 may verify the authenticity of the receiving device 112. The authenticating performed by the authentication module 132 may be performed onsite or remotely, and may be performed in advance of the receiving device 112 coming within a proximity of the locked space. Alternatively to the authentication database 113, the transactions and/or details may be stored on the publicly distributed transactions ledger 113, wherein the computing system 120 may access the ledger 113 for authentication purposes.

Alternatively, the authentication database 113 may include data and/or information on a parcel being shipped to a locked delivery receptacle at a particular location by a drone. The drone delivering the parcel may have a receiving device 112 component, and may approach the locked delivery box to deliver the parcel. The receiving device 112 of the drone may send a request to the computing system 120 as part of an authenticating step of providing access to the locked space. In response to receiving the request, the authentication module 132 of the computing system 120 may access authentication database 113 to verify that indeed the delivery receptacle is expecting a parcel delivery on that particular day. As part of the request, the receiving device 112 may also transmit unique identifying information of the parcel to the computing system 120, which may also be stored on the authentication database 113. Thus, the authentication module 132 may verify the authenticity of the receiving device 112. The authenticating performed by the authentication module 132 may be performed onsite or remotely, and may be performed in advance of the receiving device 112 coming within a proximity of the locked space. Alternatively to the authentication database 113, the transactions and/or details may be stored on the publicly distributed transactions ledger 113, wherein the computing system 120 may access the ledger 113 for authentication purposes.

Furthermore, embodiments of the computing system 120 may utilize one or more input mechanisms 110 for authentication purposes. For example, if input mechanism 110 detects a presence of a receiving device 112 nearby the locked space, a signal may be sent to the authentication module 132 of the computing system 120. In response to receiving the signal from the input mechanism 110, the authentication module 132 may verify that the receiving device 112 approaching the locked space is either requesting access or has already been authenticated by the authentication module 132. In an exemplary embodiment, the computing system 120 may utilize data and/or information captured by the input mechanism 110 to cross-reference, confirm, bolster, verify, etc. the data and/or information retrieved from the authentication database. For example, a previously authenticated receiving device possessed by a repairman may approach a locked space, such as a front door of a home. A camera positioned proximate the front door of the home may capture an image of a badge or other credentials of the repairman to verify that the authenticated receiving device 112 is possessed by the actual repairman. The camera or other sensor or input mechanism 110 may instead perform a retinal scan of the visitor (or generally obtain a biometric signature of the visitor) to ensure that the identity of the repairman matches records retrieved from the authentication database 113.

While the receiving device 112 may need to be authenticated by the computing system 120 prior to unlocking the locked space, authentication alone may not be sufficient for accessing the locked space. Embodiments of the computing system 120 may include a decryption module 133, which may include one or more components of hardware and/or software program code for transmitting a private key (or public key) and a digital signature to an authenticated receiving device 112. For instance, embodiments of the decryption module 133 may transmit the private key and the digital signature to the receiving device 112 so that the receiving device 112 can decrypt the digital signature using the private key to obtain the hashed access code or access code. Because the digital signature represents an encrypted hashed access code or encrypted access code that was encrypted using the public key (or alternatively the private key), the private key (or alternatively the public key) may be used to decrypt the digital signature to obtain the hashed access code or access code. In an exemplary embodiment, the decryption module 133 may instruct the receiving device 112, upon transmission of the private key and the digital signature, to decrypt the digital signature and obtain the hashed access code. In another embodiment, the decryption module 133 of the computing system 120 may transmit the private key to the receiving device 112, and instruct the receiving device 112 to access the ledger 113 and view the hashed access code on the blockchain using the private key. After using the private key to obtain the hashed access code or access code, the receiving device 112 may transmit the hashed access code to the decryption module 133. The decryption module 133 may compare the received hashed access code to the hashed code stored on the blockchain, and if the received hashed access code is the same as the hashed access code stored on the blockchain, then the computing system 120 may allow access to the locked space. Because of the immutable characteristics of the blockchain, the computing system 120 can be confident that a match between the hashed access code sent by the authenticated receiving device 112 and the hashed access code stored on the blockchain is authentic or valid.

Referring still to FIG. 1, embodiments of the computing system 120 may include an access module 134. Embodiments of the access module 134 may include one or more components of hardware and/or software program code for providing access to a locked space. For example, embodiments of the access module 134 may communicate with a locking mechanism 111 to unlock or lock a locking device associated with the locked space. Embodiments of the locking mechanism 111 may be real or virtual, as described supra. In response to the computing system 120 receiving a valid hashed access code, the access module 134 may actuate the locking mechanism 111 to move from a locked position to an unlocked position. Moving from the locked position to the unlocked position may allow a person to gain access to the locked space. For instance, a tangible locking device of a delivery receptacle for receiving packages may be controlled by the access module 134 to switch from a locked position to an unlocked position, allowing a delivery person or unmanned aerial vehicle (e.g. drone) to insert or otherwise place the package into the interior space of the delivery receptacle. Likewise, an electronic door lock may be controlled by the access module 134 to actuate a deadbolt lock on a front door or a home to allow a repairmen to gain access to a home, in response to the computing system 120 receiving a valid hashed access code from the repairmen via a receiving device operated, worn, or otherwise possessed by the repairmen. Further, the access module 134 may send a communication signal to a locking program running on a computing device to “unlock” the computer to allow a person to log-in or access the computing device, in response to receiving the hashed access code from the receiving device 112. Embodiments of the access module 134 may send a locking command to the locking mechanism 111 associated with the locked space, wherein the locking mechanism 111 is operably coupled to the computing system via I/O interface 150 or over network 107, to control and/or regulate access to the locked space, in response to the computing system 120 receiving a valid hashed access code.

Furthermore, embodiments of the access module 134 may send a locking signal to the locking mechanism 111 that includes one or more conditions. For instance, the computing system 120 may control and/or regulate a length of time that access will be granted to the locked space. The access module 134 may instruct the locking mechanism 111 to move to an unlocked position for a limited amount of time, and then move back to the locked position once that amount of time has passed. As an example, if the delivery receptacle has been unlocked by the access module 134 for 15 seconds, the delivery person or drone can insert the package into the delivery receptacle, and the delivery receptacle will automatically move back to the locking position. The length of time access is granted may vary from embodiment to embodiment, depending on the nature of the locked space. Additionally, the access module 134 may lock and unlock the locking mechanism 111 based on a movement to and from the locked space. For instance, if a repairmen gains access to the home, then the access module 134 may communicate with one or more input mechanisms 110 to detect whether the repairman is still onsite, and if no longer onsite, may automatically lock the locking mechanism 111. Further information can be gathered from the input mechanisms 110 to determine whether or not to revoke the access provided and lock the locking mechanism 110. In an exemplary embodiment, as the repairman leaves, the repairman may display his badge to a camera, which will then notify the computing system 120 that the job is complete, and the locked space should be switched from an unlocked position to the locked position. Various embodiments of a locked space may be used in accordance with embodiments of the present invention, wherein the access module 134 of the computing system controls and/or regulates access to the locked space.

In embodiments involving a smart delivery receptacle or other locked spaces that may be portable, embodiments of the computing system 120 may utilize a geolocation lock feature, which may hinder or prevent unauthorized access if the smart delivery receptacle is physically moved from an initial geographic location. The initial location of the smart delivery receptacle may be assigned an access point in which the locking and unlocking of the locking mechanism may be enabled. For example, provided the delivery receptacle is located within the access point, or within a certain allowable proximity to the access point, the locking mechanism 111 may be enabled, allowing an unlocking and locking performed as described above by the access module 134. The access point may be a particular geographical location. If the delivery receptacle has been moved outside the access point or beyond a proximity threshold to the access point, the access module 134 of the computing system 120 may disable the locking mechanism 111 such that the locking mechanism 111 may not function to move to an unlocked position, even if the receiving device 112 is authenticated and within the predefined proximity to the receptacle. In this way, if the receptacle is moved, stolen, displaced, even by an authenticated individual or drone, the unlocking function of the receptacle is disabled and cannot be opened using the methods described above.

Furthermore, embodiments of the access module 134 of the computing system 120 may track a location of the receptacle. The tracking of the receptacle may be triggered by the disabling of the locking mechanism 111 to save power consumption used to constantly broadcast a location signal from the receptacle. The locating tracking may utilize a radio frequency emitted by the receptacle or by a GPS chip associated with the receptacle. In addition, the access module 134 may send an alert to the owner and/or authorities that the receptacle has been physically moved outside the access point.

In an exemplary embodiment, an input or content of a block of the ledger 113 may contain a geographic coordinate of an initial location or access point of the delivery receptacle. As part of the encryption performed by the encryption module 131, if the geographic coordinate of the delivery receptacle (e.g. after the delivery receptacle has been moved) is different than the geographic coordinate stored on the ledger 113, then the locking mechanism 111 may be disabled and then access will not be granted, even if the drone or delivery person would otherwise be authenticated.

Embodiments of the computing system 120 may be equipped with a memory device 142 which may store various information and data regarding the scanned data, and a processor 141 for implementing the tasks associated with the access control system 100.

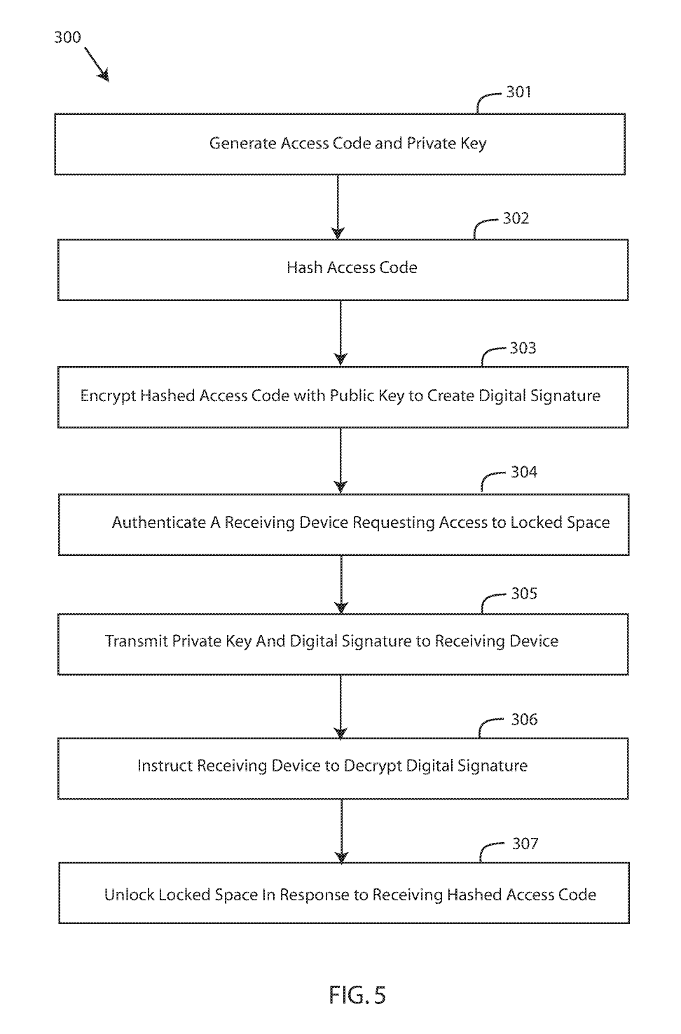

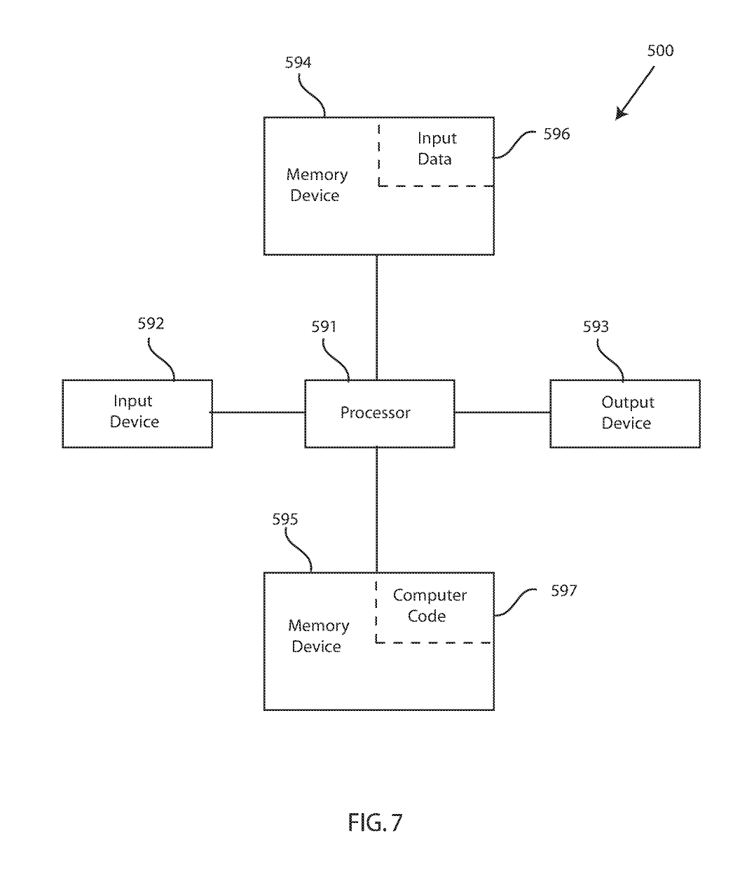

Referring now to FIG. 5, which depicts a flow chart of a method 300 for controlling access to a locked space, in accordance with embodiments of the present invention. One embodiment of a method 300 or algorithm that may be implemented for controlling access to a locked space in accordance with the access control system 100 described in FIG. 1 using one or more computer systems as defined generically in FIG. 7 below, and more specifically by the specific embodiments of FIG. 1.

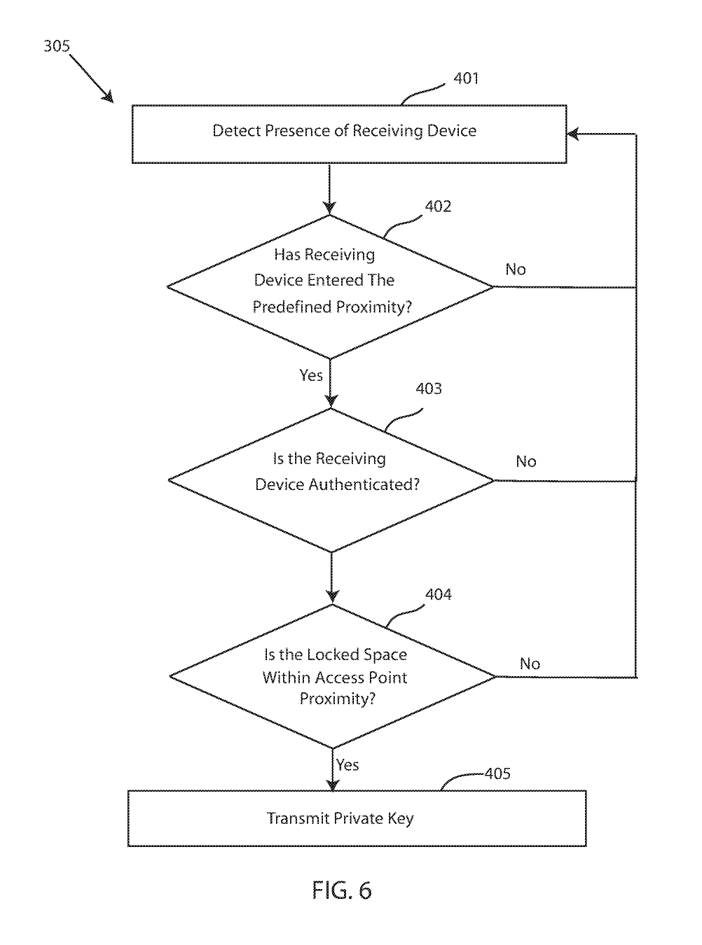

Embodiments of the method 300 for controlling access to a locked space may begin at step 301 wherein an access code and a private key are generated by the computing system 120. Step 302 hashes the access code so that a size of the data can be uniform, or a fixed size. Step 303 encrypts the hashes access code with a public key to create a digital signature. The digital signature may be stored on the blockchain, to ensure that the hashed access code is not modified. Step 304 authenticates a receiving device 112 that is requesting permission to access a locked space. Authentication may include accessing the authentication database 113 and/or accessing the publicly distributable transactions ledger 113 (i.e. blockchain). Step 305 transmits the private key and digital signature to authenticated receiving device 112. FIG. 6 depicts a flow chart of a step of the method for controlling access to a locked space of FIG. 5, in accordance with embodiments of the present invention. The step of transmitting the private key and digital signature to the authenticated receiving device 112 may include step 401, which detects a presence of the receiving device 112. The presence of the receiving device 112 may be detected or otherwise received by one or more input mechanisms 110. Step 402 determines whether the receiving device 112 has entered within a predefined proximity to the locked space. If not, then the step 401 continues to detect a presence. If yes, then step 402 determines whether the receiving device 112 that has entered the proximity is authenticated. If not, then step 401 continues to detect a presence of a receiving device. If yes, then step 404 transmits the private key to the receiving device 112.

Referring back to FIG. 5, step 306 instructs the authenticated receiving device 112 to decrypt the digital signature the authenticated using the private key to obtain the hashed access code, and transmit the hashed access code to the computing system 120. The receiving device 112 may then obtain the hashed access code, and then transmit the hashed access code to the computing system 120. Step 307 unlocks the locked space in response to receiving the hashed access code from the receiving device 112. Prior to communicating with the locking mechanism 111 to unlock the locked space, the computing system 120 may access the blockchain to confirm that the hashed access code received from the receiving device matches the hashed access code stored on the blockchain, which cannot be modified. Additionally, a new transaction may be generated when the locking space is unlocked, to prevent any additional unauthorized uses of the hashed access code.

FIG. 7 illustrates a block diagram of a computer system for the access control system of FIG. 1, capable of implementing methods for controlling access to a locked space of FIG. 5, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for controlling access to a locked space, in the manner prescribed by the embodiments of FIG. 5 using the access control system of FIG. 1, wherein the instructions of the computer code 597 may be executed by processor 591 via memory device 595. The computer code 597 may include software or program instructions that may implement one or more algorithms for implementing the methods for controlling access to a locked space, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 6.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the input mechanism 110 or locking mechanism 111. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to access controlling or regulating systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to control access to a locked space. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for controlling access to a locked space. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for controlling access to a locked space.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for controlling access to a locked space, comprising:
generating, by a processor of a computing system, an access code and a private key associated with the access code, the access code being used to gain access to the locked space;
hashing, by the processor, the access code to obtain a hashed access code;
encrypting, by the processor, the hashed access code with a public key to create a digital signature, wherein the hashed access code and the digital signature are stored on a block of a blockchain;
authenticating, by the processor, a receiving device in response to a request from the receiving device to gain access to the locked space;
transmitting, by the processor, the private key and the digital signature to an authenticated receiving device;
instructing, by the processor, the authenticated receiving device to decrypt the digital signature using the private key to obtain the hashed access code, and transmit the hashed access code to the computing system; and
unlocking, by the processor, the locked space in response to receiving the hashed access code from the receiving device.

2. The method of claim 1, wherein one or more input mechanisms coupled to the computing system detect a presence of the receiving device, within a predefined proximity of the locked space, further wherein the private key is transmitted in response to the receiving device entering the predefined proximity to the locked space.

3. The method of claim 1, wherein the locked space is accessible for a limited time, and when the limited time passes, the private key is no longer valid to gain access to locked space and a new access code is generated.

4. The method of claim 1, wherein the locked space is a delivery receptacle located at a delivery location, and the receiving device is a mobile computing device operated by a parcel company.

5. The method of claim 1, wherein the access code remains unknown to the receiving device.

6. The method of claim 1, further comprising generating a transaction on the blockchain that the receiving device gained access to the locked space.

7. The method of claim 1, wherein the blockchain prevents the computing system from transmitting more than a single private key.

8. A computer system, comprising:
a processor;
at least one input mechanism coupled to the processor;
a memory device coupled to the processor; and
a computer readable storage device coupled to the processor, wherein the storage device contains program code executable by the processor via the memory device to implement a method for controlling access to a locked space, the method comprising:
generating, by a processor of a computing system, an access code and a private key associated with the access code, the access code being used to gain access to the locked space;
hashing, by the processor, the access code to obtain a hashed access code;
encrypting, by the processor, the hashed access code with a public key to create a digital signature, wherein the hashed access code and the digital signature are stored on a block of a blockchain;
authenticating, by the processor, a receiving device in response to a request from the receiving device to gain access to the locked space;
transmitting, by the processor, the private key and the digital signature to an authenticated receiving device;
instructing, by the processor, the receiving device to decrypt the digital signature using the private key to obtain the hashed access code, and transmit the hashed access code to the computing system; and
unlocking, by the processor, the locked space in response to receiving the hashed access code from the receiving device.

9. The computer system of claim 8, wherein one or more input mechanisms coupled to the computing system detect a presence of the receiving device, within a predefined proximity of the locked space, further wherein the private key is transmitted in response to the receiving device entering the predefined proximity to the locked space.

10. The computer system of claim 8, wherein the locked space is accessible for a limited time, and when the limited time passes, the private key is no longer valid to gain access to locked space and a new access code is generated.

11. The computer system of claim 8, wherein the locked space is a delivery receptacle located at a delivery location, and the receiving device is a mobile computing device operated by a parcel company.

12. The computer system of claim 8, wherein the access code remains unknown to the receiving device.

13. The computer system of claim 8, further comprising generating a transaction on the blockchain that the receiving device gained access to the locked space.

14. The computer system of claim 8, wherein the blockchain prevents the computing system from transmitting more than a single private key.

15. A computer program product, comprising a computer readable hardware storage device storing a computer readable program code, the computer readable program code comprising an algorithm that when executed by a computer processor of a computing system implements a method for controlling access to a locked space, comprising:
generating, by a processor of a computing system, an access code and a private key associated with the access code, the access code being used to gain access to the locked space;
hashing, by the processor, the access code to obtain a hashed access code;
encrypting, by the processor, the hashed access code with a public key to create a digital signature, wherein the hashed access code and the digital signature are stored on a block of a blockchain;
authenticating, by the processor, a receiving device in response to a request from the receiving device to gain access to the locked space;
transmitting, by the processor, the private key and the digital signature to an authenticated receiving device;
instructing, by the processor, the receiving device to decrypt the digital signature using the private key to obtain the hashed access code, and transmit the hashed access code to the computing system; and
unlocking, by the processor, the locked space in response to receiving the hashed access code from the receiving device.

16. The computer program product of claim 15, wherein one or more input mechanisms coupled to the computing system detect a presence of the receiving device, within a predefined proximity of the locked space, further wherein the private key is transmitted in response to the receiving device entering the predefined proximity to the locked space.

17. The computer program product of claim 15, wherein the locked space is accessible for a limited time, and when the limited time passes, the private key is no longer valid to gain access to locked space and a new access code is generated.

18. The computer program product of claim 15, wherein the locked space is a delivery receptacle located at a delivery location, and the receiving device is a mobile computing device operated by a parcel company.

19. The computer program product of claim 15, further comprising generating a transaction on the blockchain that the receiving device gained access to the locked space.

20. The computer program product of claim 15, wherein the blockchain prevents the computing system from transmitting more than a single private key.
